(19) United States
(12) Patent Application Publication
(10) Pub. No.: US 2004/0104540 A1
(43) Pub. Date: Jun. 3, 2004

(54) Seal configuration to reduce seal extrusion

(76) Inventors: Dean Foote, Edmonton (CA); Clayton Delbridge, Edmonton (CA); Scott Delbridge, Devon (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/723,846

(22) Filed: Nov. 26, 2003

(30) Foreign Application Priority Data
Nov. 28, 2002 (CA) 2,413,112

(51) Int. Cl. F16J 15/02

(52) U.S. Cl. 277/637

(57) ABSTRACT

A seal configuration to reduce seal extrusion includes a body having an opening with inwardly tapered peripheral sidewalls. A closure having an attachment portion larger than the opening and an axially projecting stopper portion adapted to fit closely within the opening. The stopper portion has an endless peripheral seal groove extending in spaced relation around the axis in which is positioned a peripheral seal which conforms to the tapered peripheral sidewalls. A backing ring of pliable memory retaining material is positioned between the peripheral seal groove and the attachment portion of the closure. The backing ring resists extrusion flow under pressure. In response to an increase in internal pressure within the body, the peripheral seal is extruded against the backing ring which deforms to prevent the peripheral seal from entering the extrusion gaps.

### FIELD OF THE INVENTION

The present invention relates to a seal configuration which is intended to reduce seal extrusion under pressure.

### BACKGROUND OF THE INVENTION

There are various applications in which seal life is reduced by extrusion of the seals when under pressure. An example of such an application is with closure doors on pressure vessels. Closure doors on pressure vessels are frequently positioned on studs and held in place by nuts. A face seal is generally positioned between the closure door and the pressure vessel. As pressure increases, the studs elastically deform and create a small gap. Pressure from inside the pressure vessel acting upon the seal, causes a portion of the seal to be extruded into the gap. That portion of the seal extending into the gap then becomes pinched when pressure is relieved and the gap closes. Repeated pinching of the seal, leads to premature seal failure.

### SUMMARY OF THE INVENTION

What is required is a seal configuration which will reduce or eliminate seal extrusion.

According to the present invention there is provided a seal configuration to reduce seal extrusion which includes a body adapted to contain internal pressure having an opening with inwardly tapered peripheral sidewalls. A closure is provided which is adapted to close the opening. The closure has an attachment portion larger than the opening and an axially projecting stopper portion adapted to fit closely within the opening. The stopper portion has an endless peripheral seal groove extending in spaced relation around the axis in which is positioned a peripheral seal. The peripheral seal is adapted to sealingly engage the tapered peripheral sidewalls of the body in interference fit relation, thereby conforming to the tapered peripheral sidewalls. A backing ring of pliable memory retaining material is positioned between the peripheral seal groove and the attachment portion of the closure. The backing ring engages the tapered peripheral sidewalls of the body in interference fit relation conforming to the tapered peripheral sidewalls, while being sufficiently stiff as to resist extrusion flow under pressure. When the peripheral seal deforms in response to an increase in internal pressure within the body and extrusion gaps begin to form between the attachment portion of the closure and the body, the peripheral seal is extruded against the backing ring which deforms to prevent the peripheral seal from entering the extrusion gaps.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a side elevation view, in section, of a seal configuration to reduce seal extrusion fabricated in accordance with the teachings of the present invention, with closure spaced from opening in body of pressure vessel.

FIG. 2 is a detailed side elevation view, in section, of a seal configuration to reduce seal extrusion fabricated in accordance with the teachings of the present invention, with closure spaced from opening in body of pressure vessel.

FIG. 3 is a detailed side elevation view, in section, of the seal configuration illustrated in FIG. 2, with peripheral seal deforming to conform to tapered sidewalls of opening as the closure is secured in position.

FIG. 4 is a detailed side elevation view, in section, of the seal configuration illustrated in FIG. 2, with backing ring deforming to conform to tapered sidewalls of opening as the closure is secured in position.

FIG. 5 is a detailed side elevation view, in section, of the seal configuration illustrated in FIG. 4, prior to pressure being applied.

FIG. 6 is a detailed side elevation view, in section, of the seal configuration illustrated in FIG. 4, as pressure is applied.

FIG. 7 is a detailed side elevation view, in section, of the seal configuration illustrated in FIG. 4, under pressure sufficient to extrude the peripheral seal.

### DETAILED DESCRIPTION OF THE PREFERRED EMBODIMENT

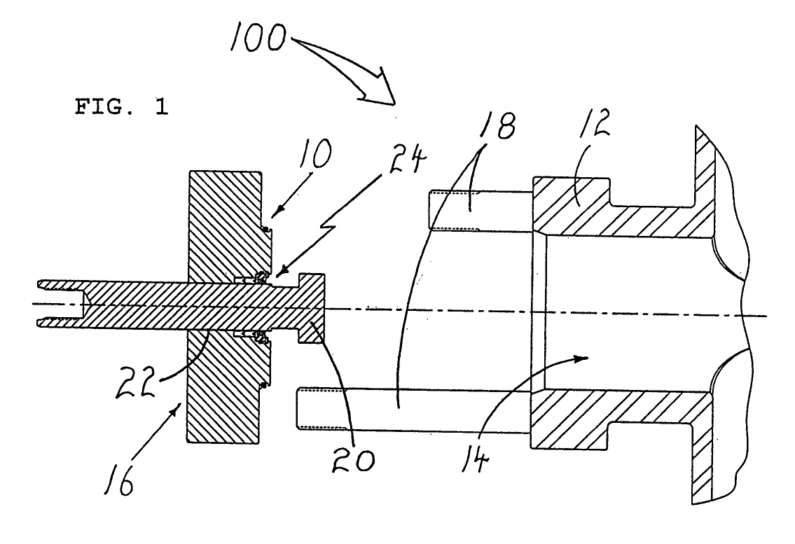

The preferred embodiment, a seal configuration to reduce seal extrusion under pressure generally identified by reference numeral 10, will now be described with reference to FIGS. 1 through 7. For the purpose of illustrating the utility of the invention a closure door from a blow out preventer will be illustrated and described.

Structure and Relationship of Parts:

Referring to FIG. 1, there will first be described the environment of the blow out preventer, generally identified by reference numeral 100 in which seal configuration 10 is positioned. Blow out preventer 100 has a main body 12 with an opening 14. A closure 16 is provided which is adapted to close opening 14. Closure 16 is mounted on a plurality of studs 18 which extend from body 12. Once in position, closure 16 is prevented from removal from studs 18 by nuts (not shown). In this application, being a blow out preventer, pistons 20 extend through a passage 22 in closure 16. When in operation, pistons 20 move back and forth to position sealing rams (not shown). A seal assembly, generally indicated by reference numeral 24, provides a dynamic seal between piston 20 and passage 22. Seal assembly 24 is not relevant to the present invention and will, therefore, not be further described.

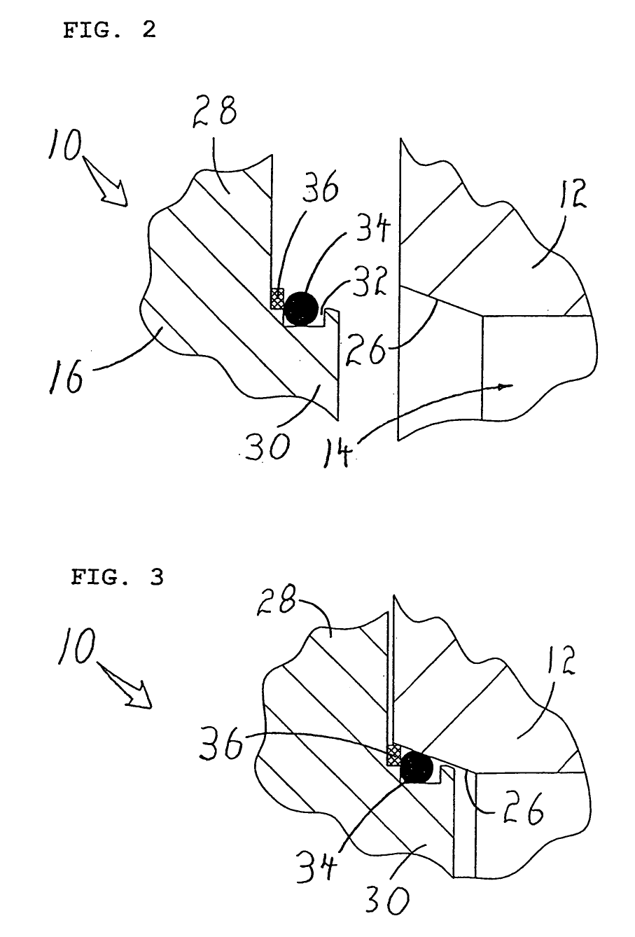

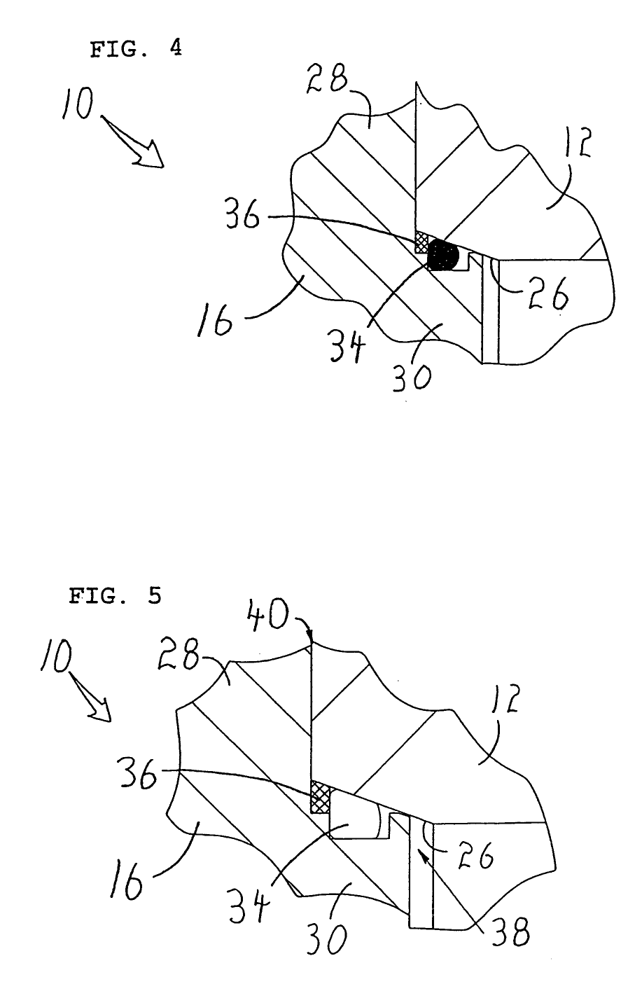

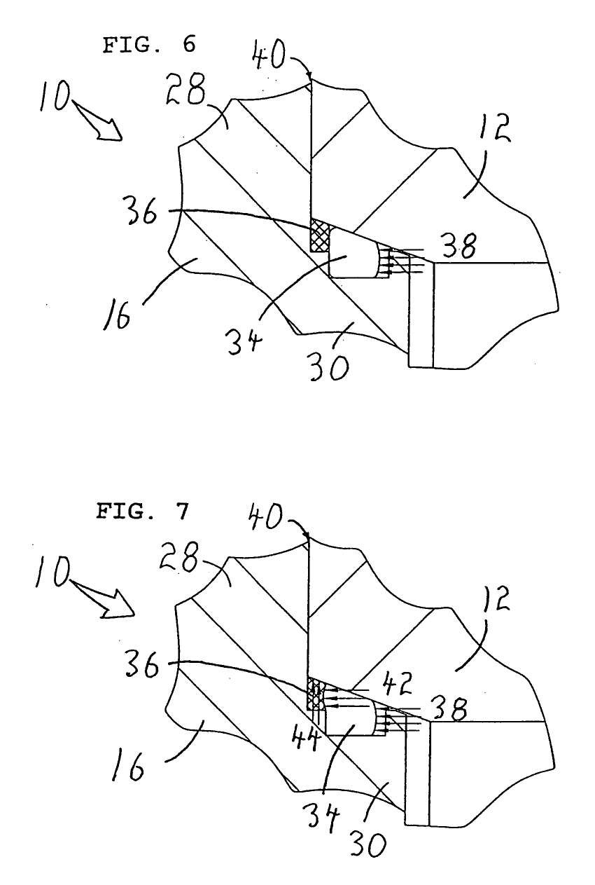

Referring to FIG. 2, seal configuration 10 is adapted to contain internal pressure within body 12. Opening 14 in body 12 has inwardly tapered peripheral sidewalls 26. Closure 16 has an attachment portion 28 which is larger than the opening and an axially projecting stopper portion 30 that is adapted to fit closely within opening 14. Axially projecting stopper portion 30 has an endless peripheral seal groove 32 extending in spaced relation around axially projecting stopper portion 30 in which is positioned a peripheral seal 34. Referring to FIG. 3, peripheral seal 34 is adapted to sealingly engage inwardly tapered peripheral sidewalls 26 of body 12 in interference fit relation, thereby conforming to inwardly tapered peripheral sidewalls 26 as illustrated in FIG. 4. Referring to FIG. 2, a backing ring 36 of pliable memory retaining material (while being sufficiently stiff as to resist extrusion flow under pressure), is positioned between peripheral seal groove 32 and attachment portion 28 of closure 16. Referring to FIG. 3, backing ring 36 engages inwardly tapered peripheral sidewalls 26 of body 12 in interference fit relation conforming to inwardly tapered peripheral sidewalls 26 as illustrated in FIG. 4. Referring to FIG. 5, as pressure 38 within body 12 increases, peripheral seal 34 begins to adapt. Pressure induced extrusion gaps 40 may appear between attachment portion 28 of closure 16 and body 12. Referring to FIG. 6, peripheral seal 34 is pushed back against attachment portion 28 of closure 16 and backing ring 36. Referring to FIG. 7, as further pressure 42 is applied, backing ring 36 responds by changing shape, transmitting sealing pressure 44 at potential extrusion gap 40.

Operation:

The operation of seal configuration 10 will now be described with reference to FIGS. 1 through 7. Referring to FIG. 3, Peripheral seal 34 is engaged against inwardly tapered peripheral sidewalls 26 of body 12 in interference fit relation conforming to inwardly tapered peripheral sidewalls 26 as illustrated in FIG. 4. Referring to FIG. 3, Backing ring 36 is engaged against inwardly tapered peripheral sidewalls 26 of body 12 in interference fit relation conforming to inwardly tapered peripheral sidewalls 26 as illustrated in FIG. 4. Backing ring 36 is pliable while being sufficiently stiff as to resist extrusion flow under pressure. Referring to FIGS. 5 through 7, with particular regard to FIG. 7, when peripheral seal 34 deforms in response to an increase in internal pressure within body 12, peripheral seal 34 is extruded against backing ring 36 which deforms to prevent peripheral seal 34 from entering any extrusion gaps 40 which may have formed. Further, backing ring 36, by virtue of its non-compressible composition, is able to exert sealing pressure 44 upon any extrusion gap 40 without entering the extrusion gap 40 itself. This ability to reduce seal extrusion 10 represents a significant improvement over prior art systems.

### EXAMPLE

Body 12 might have an 8-inch diameter circular bore area resulting in an area of 50.2 square inches. At 5000 psi, studs 18 (fastened with nuts) must hold a door against 251,300 pounds of pressure. If a standard face seal is used that has an outside diameter of 9 inches, the resulting area and load are 63.6 square inches and 318,000 pounds respectively. This is an increase in load of 26.5%. Not only do studs 18 require additional strength, but they must also have sufficient torque applied to the nuts to pre-load them. This is necessary because the force applied to the door will stretch studs 18 elastically and create an extrusion gap 40 between the attachment portion 28 of closure 16 and body 12. Further, the pressure inside close opening 14 of body 12 can cause extrusion of a standard face seal into the extrusion gap and damage the seal when the pressure is relieved. Repeated cycles of high pressure can lead to seal failure. The higher loads also require the doors to be thicker in order to limit flexing of the doors. Gaps may develop to damage the seals if the doors are not stiff enough to limit flexing. According to the teachings of the present invention, a seal configuration is provided that limits seal extrusion and does so by limiting the pressure to a smaller surface, reducing the pressure area and resulting load on studs 18. As a result, manufacturing tolerances have a higher level of forgiveness. Further, the configuration itself of the present invention helps to stiffen the door.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A seal configuration, comprising:
a body adapted to contain internal pressure having an opening with inwardly tapered peripheral sidewalls;
a closure adapted to close the opening, the closure having an attachment portion larger than the opening and an axially projecting stopper portion adapted to fit closely within the opening, the stopper portion having an endless peripheral seal groove extending in spaced relation around the axis in which is positioned a peripheral seal adapted to sealingly engage the tapered peripheral sidewalls of the body in interference fit relation, thereby conforming to the tapered peripheral sidewalls; and
a backing ring of pliable memory retaining material positioned between the peripheral seal groove and the attachment portion of the closure, the backing ring engaging the tapered peripheral sidewalls of the body in interference fit relation and conforming to the tapered peripheral sidewalls while being sufficiently stiff as to resist extrusion flow under pressure, such that when the peripheral seal deforms in response to an increase in internal pressure within the body and extrusion gaps begin to form between the attachment portion of the closure and the body, the peripheral seal is extruded against the backing ring which deforms to prevent the peripheral seal from entering the extrusion gaps.
